(19) United States
(12) Patent Application Publication
(10) Pub. No.: US 2016/0110668 A1
(43) Pub. Date: Apr. 21, 2016

(54) Digital Records Management

(71) Applicant: Bank of America Corporation, Charlotte, NC (US)

(72) Inventors: Bryan Ford, Allen, TX (US); Susan K. Goodman, Mount Vernon, NY (US); Kirk A. Halliburton, Charlotte, NC (US); Karen W. Heuberger, Charlotte, NC (US); Sherrye C. Banker, Belmont, NC (US); Robert S. Louer, Charlotte, NC (US); Carlisle Rice, Katy, TX (US); David A. Uitemarkt, Chicago, IL (US)

(21) Appl. No.: 14/980,509

(22) Filed: Dec. 28, 2015

Related U.S. Application Data
(63) Continuation of application No. 12/698,685, filed on Feb. 2, 2010.

(51) Int. Cl. G06Q 10/06; G06Q 30/00; G06F 17/30

(52) U.S. Cl. CPC G06Q 10/06313; G06F 17/30365; G06Q 30/018

(57) ABSTRACT

Record management of a business unit is aligned to a digital records policy of a business enterprise. The digital records policy may require process, technology and cultural changes to shift from paper to digital records management. Paper intensive processes tend to have a number of economic, environmental, and operational disadvantages. In addition, government regulations are increasingly requiring businesses to be able to locate and retrieve information quickly. An implementation document contains information about a business process so that a business process supporting digital records may be compared with a digital records policy of the business enterprise. If there are any gaps between the business process and the digital records policy, an action plan may be constructed in order to eliminate or mitigate the gaps. Also, the economic benefits for a business unit migrating to digital records may be analyzed by a business case wizard tool.

### CROSS-REFERENCE TO RELATED APPLICATION

This application is a continuation of U.S. application Ser. No. 12/698,685 filed on Feb. 2, 2010, entitled “Digital Records Management,” which is incorporated herein by reference in its entirety.

### FIELD

Aspects of the embodiments generally relate to a computer system supporting the alignment of records management to a digital records policy.

### BACKGROUND

Records management is the practice of managing the records of an organization from the time they are created until eventual disposal of the records. This may include developing and implementing controls for capturing, classifying, storing, securing, retrieving, destroying and/or preserving records (due to archival value). It also typically includes providing support to litigation (e.g., e-discovery) and regulatory functions. Records retention schedules document the period of time that records must be retained and after which they must be destroyed, absent legal preservation notices. A record may be either a tangible object or digital information: for example, birth certificates, medical x-rays, office documents, databases, application data, and e-mail. Records management is primarily concerned with the evidence of an organization's activities, and is typically applied according to the value of the records rather than their physical format. Records management is a professional discipline, with a body of literature, professional association (ARMA), certification (ICRM) and a key standard that embodies its core requirements (ISO 15489-1 (2001)—Records Management).

Managing physical records involves different disciplines and may draw on a variety of forms of expertise. Physical records typically must be identified, authenticated, filed, and retrieved. This is usually a matter of filing and retrieval; in some circumstances, more careful handling is required. If an item is presented as a legal record, it often needs to be authenticated. Physical records often must be stored in such a way that they are accessible and safeguarded against environmental and human damage (e.g., fire, flood, industrial sabotage). A typical paper document may be stored in a filing cabinet in an office, in a file room, or in an off-site records center. In addition, physical records may be tracked while the records are away from the normal storage area. Tracking may be handled by simple written recording procedures or by a computerized system. When physical records are no longer needed in an onsite location, the physical records are often removed, where records may be destroyed or transferred to an archive. Destruction of records in the absence of legal holds should be authorized by the organization's retention schedule, which is based upon all of the following: law, statute, regulation, industry standard and operating requirements, and the records should be disposed of with care to avoid inadvertent disclosure of information. The process needs to be well-documented, starting with the aforementioned records retention schedule, where policies and procedures have been approved at the highest level.

Many organizations are migrating from physical records to digital records in order to realize cost reductions as well as to facilitate the management of the records. While the general principles of records management apply to records in any format, digital records (typically referred to as electronic records) may raise additional issues. For example, it may be more difficult to ensure that the content, context and structure of records is preserved and protected when the records do not have a physical existence.

Records management has increased interest among corporations due to new compliance regulations and statutes. While government, legal, and healthcare entities have a strong historical records management discipline, general record-keeping of corporate records has been poorly standardized and implemented. In addition, scandals such as the Enron/Andersen scandal, and more recently records-related mishaps at Morgan Stanley, have renewed interest in corporate records compliance, retention period requirements, litigation preparedness, and related issues. Statutes such as the US Sarbanes-Oxley Act have created new concerns among corporate “compliance officers” that result in more standardization of records management practices within an organization. During most of the 1990's, there have been discussions between records managers and IT managers, and the emphasis of this communication has expanded to include the legal aspects, as it is now focused on compliance and risk. Also, privacy, data protection, and cross-border data flow have become issues of interest for records managers. The role of the records manager to aid in the protection of an organization's records has often grown to include attention to these concerns. The need to ensure that certain information about individuals is not retained has brought greater focus to records retention schedules and records destruction.

Consequently, providing digital records management that addresses the above-mentioned concerns is important to the operations of many businesses.

### BRIEF SUMMARY

Aspects of the embodiments address one or more of the issues mentioned above by disclosing methods, computer readable media, and apparatuses in which records management of a business unit is aligned to a digital records policy of a business enterprise. The digital records policy may require process, technology and cultural changes to shift from paper to digital records management. Paper intensive processes tend to have higher costs, negative environmental impacts, increased cycle times, and more risk than electronic processes. In addition, state, federal and international regulations are increasingly requiring businesses to be able to locate and retrieve information quickly.

Another aspect of the embodiments is an implementation document that incorporates key requirements (in the form of questions and lists) necessary to implement the policy and related requirements. Information about a business process and related technologies that support the records of a business unit within a business enterprise is collected and compared with the requirements of the digital records policy of the business enterprise. It is then determined whether there are any gaps between the business process and the digital records policy that require mitigation in order for the records in that system and process to be considered trustworthy. However, these gaps may not be considered gaps in the paper-based records environment.

An action plan may be constructed in order to eliminate or mitigate the gaps.

With another aspect of the embodiments, the economic benefits for a business unit migrating to digital records from paper records are analyzed by a business case wizard tool. An exception for a gap may be granted, if the corresponding economic benefit is not sufficient.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the embodiments may be implemented.

FIG. 2 is an illustrative block diagram of workstations and servers that may be used to implement the processes and functions of certain aspects of the embodiments.

FIG. 3 shows a list of project team responsibilities for an enterprise digital records program in accordance with various aspects of the embodiments.

FIG. 4 shows a project activities process for an enterprise digital records program in accordance with various aspects of the embodiments.

FIG. 5 shows a flow diagram during a define stage of an enterprise digital records program in accordance with various aspects of the embodiments.

FIG. 6 shows an illustrative summary sheet of a business case wizard tool in accordance with various aspects of the embodiments.

FIG. 7 shows a flow diagram during a measure stage of an enterprise digital records program in accordance with various aspects of the embodiments.

FIG. 8 shows a flow diagram during an analyze stage of an enterprise digital records program in accordance with various aspects of the embodiments.

FIG. 9 shows a flow diagram during an improve stage of an enterprise digital records program in accordance with various aspects of the embodiments.

FIG. 10 shows a flow diagram during a control stage of an enterprise digital records program in accordance with various aspects of the embodiments.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

In the description herein, the following terms are referenced.

Business enterprise: A business entity that provides goods and/or services. A business enterprise may vary in size from a one-person sole proprietorship to an international corporation having different lines of business, billions of dollars in assets, and thousands of employees. The size of a business unit within the business enterprise typically varies in size based on the size of the enterprise itself. For example, a business unit may be a line of business in a large business enterprise or may encompass the entire enterprise for a small business enterprise.

Digital records: Information that documents business functions, activities and/or transactions in a form that requires a computer or digital device to process it, such as email, Microsoft Office documents, and electronic reports. Digital records may be created, received, processed and maintained by any associate in a line of business and/or support partners, and may be retained as evidence of business because of the information contained therein.

Metadata: “Data about data” of any sort in any media. An item of metadata may describe an individual datum, content item, or a collection of data including multiple content items and hierarchical levels, e.g., a database schema. With data processing, metadata is typically definitional data that provides information about or documentation of other data managed within an application or environment.

In accordance with various aspects of the embodiments, methods, computer-readable media, and apparatuses are disclosed in which records management of a business unit (e.g., a line of business) is aligned to a digital records policy of a business enterprise. The digital records policy may require process, technology and cultural changes to shift from paper to digital records management. Paper intensive processes tend to have higher costs, negative environmental impacts, increased cycle times, and more risk than electronic processes. In addition, state, federal and international regulations are increasingly requiring businesses to be able to locate and retrieve information quickly.

Adoption of a digital records policy of a business enterprise by its lines of business may have a number of benefits, including: 1) Create a consistent digital records management process, 2) Define and meet requirements to ensure that digital records are considered trustworthy by all stakeholders, including regulators and the courts, 3) Ensure the sufficiency of electronic systems as repositories of official company records, 4) Offset the legal risk and expense of e-discovery, and 5) Define exceptions to the mandate (e.g., where there is a unique legal requirement to maintain hard-copy records related to a specific function).

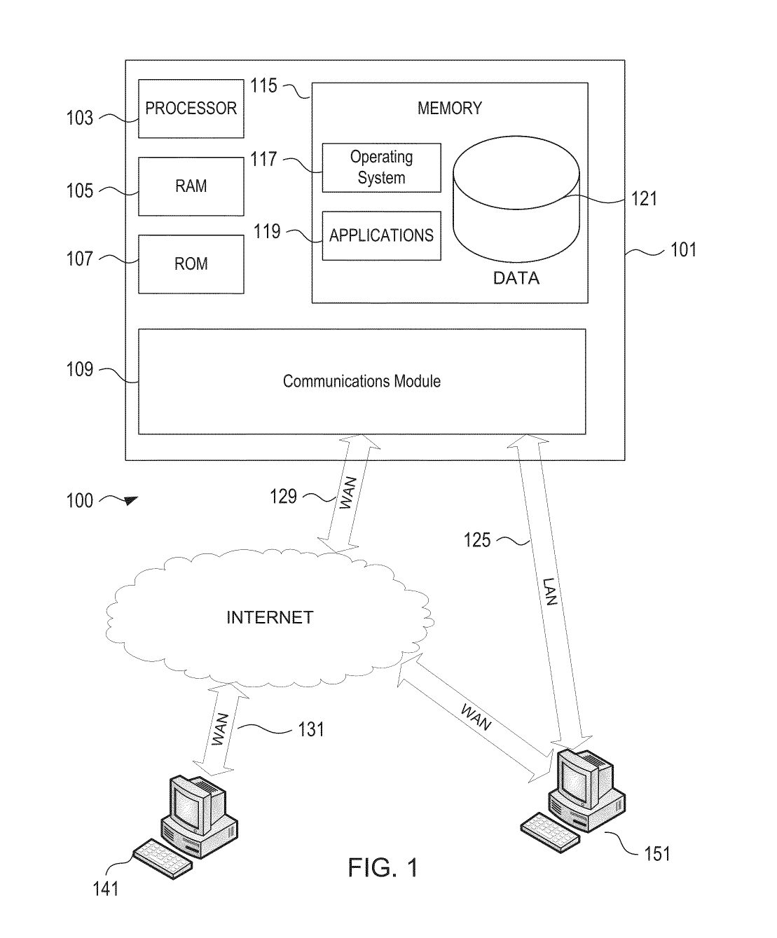

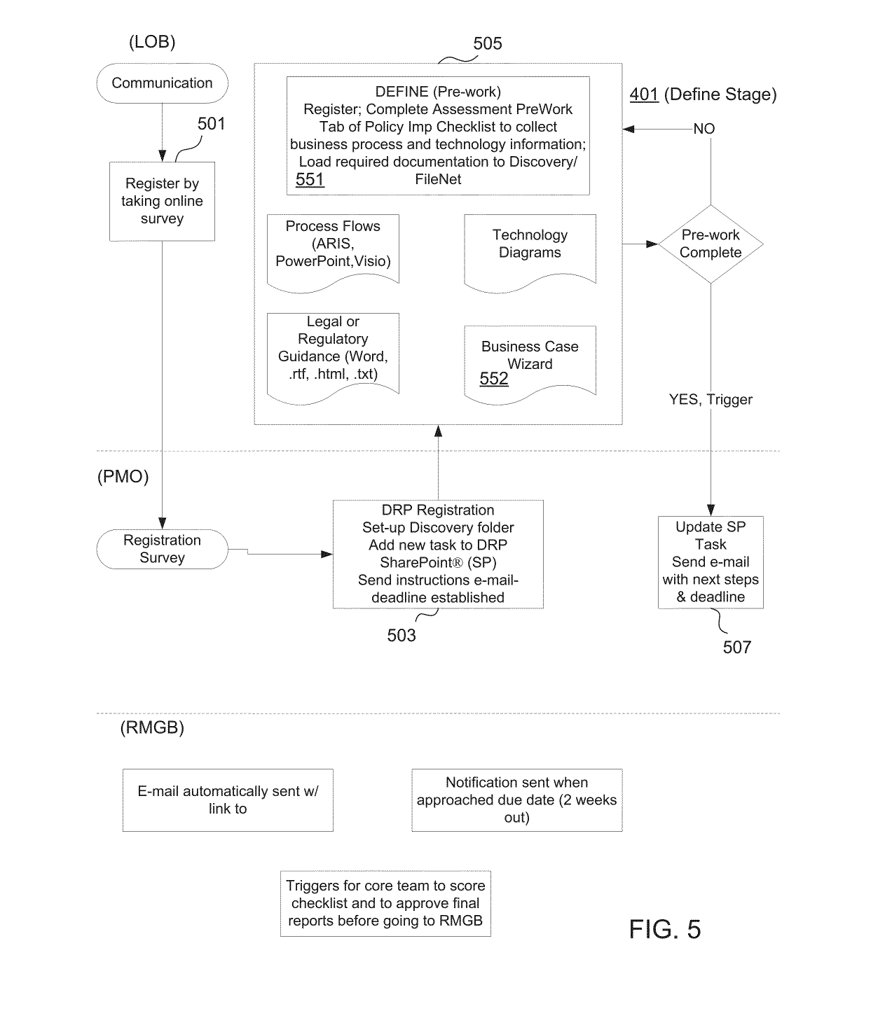

FIG. 1 illustrates an example of a suitable computing system environment 100 (e.g., for supporting processes 401, 402, 403, 404, and 405 as shown in FIGS. 5, 6, 8, 9, and 10, respectively) that may be used according to one or more illustrative embodiments. The computing system environment 100 is only one example of a suitable computing environment and is not intended to suggest any limitation as to the scope of use or functionality of the embodiments. The computing system environment 100 should not be interpreted as having any dependency or requirement relating to any one or combination of components shown in the illustrative computing system environment 100.

The embodiments are operational with numerous other general purpose or special purpose computing system environments or configurations. Examples of well known computing systems, environments, and/or configurations that may be suitable for use with the embodiments include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, and the like to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown).

Database 121 may provide storage of assessment documents for an enterprise digital records management program as well as digital records themselves. While database 121 is shown to be internal to computing device 101, database 121 may be external to computing device 101 with some embodiments.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the embodiments is contemplated. For example, aspects of the method steps disclosed herein may be executed on a processor on a computing device 101. Such a processor may execute computer-executable instructions stored on a computer-readable medium.

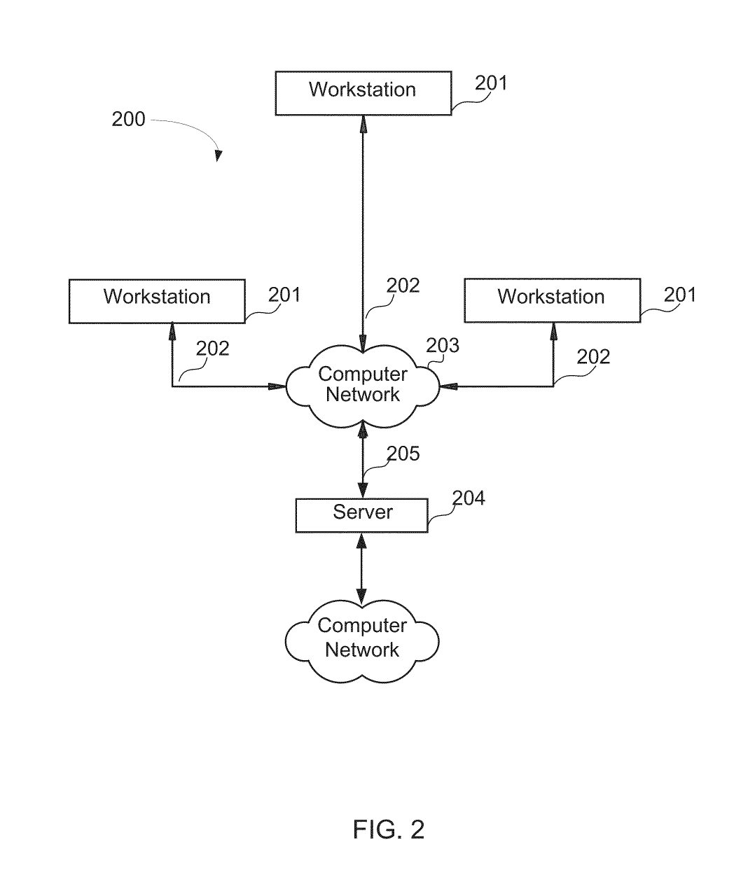

Referring to FIG. 2, an illustrative system 200 for implementing methods according to some embodiments is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, and hard-wired links. Connectivity may also be supported to a CCTV or image/iris capturing device.

Referring to FIGS. 1 and 2, computing device 101 and system 200 may utilize knowledge management to manage a digital records program for a business enterprise. For example, a machine-readable knowledge base (e.g., database 121 as shown in FIG. 1) may store knowledge in a computer-readable form, usually for the purpose of having automated deductive reasoning applied to knowledge data. The knowledge base content may contain a set of data, often in the form of rules that describe the knowledge in a logically consistent manner. Logical operators may be used to provide deduction to reason about the knowledge in the knowledge base. Some machine-readable knowledge bases may be used with artificial intelligence in order to support an expert system. The expert system may utilize a rule base and an inference engine that cooperate with each other to analyze a problem and to arrive at a conclusion.

As understood by those skilled in the art, the steps that follow in the Figures may be implemented by one or more of the components in FIGS. 1 and 2 and/or other components, including other computing devices.

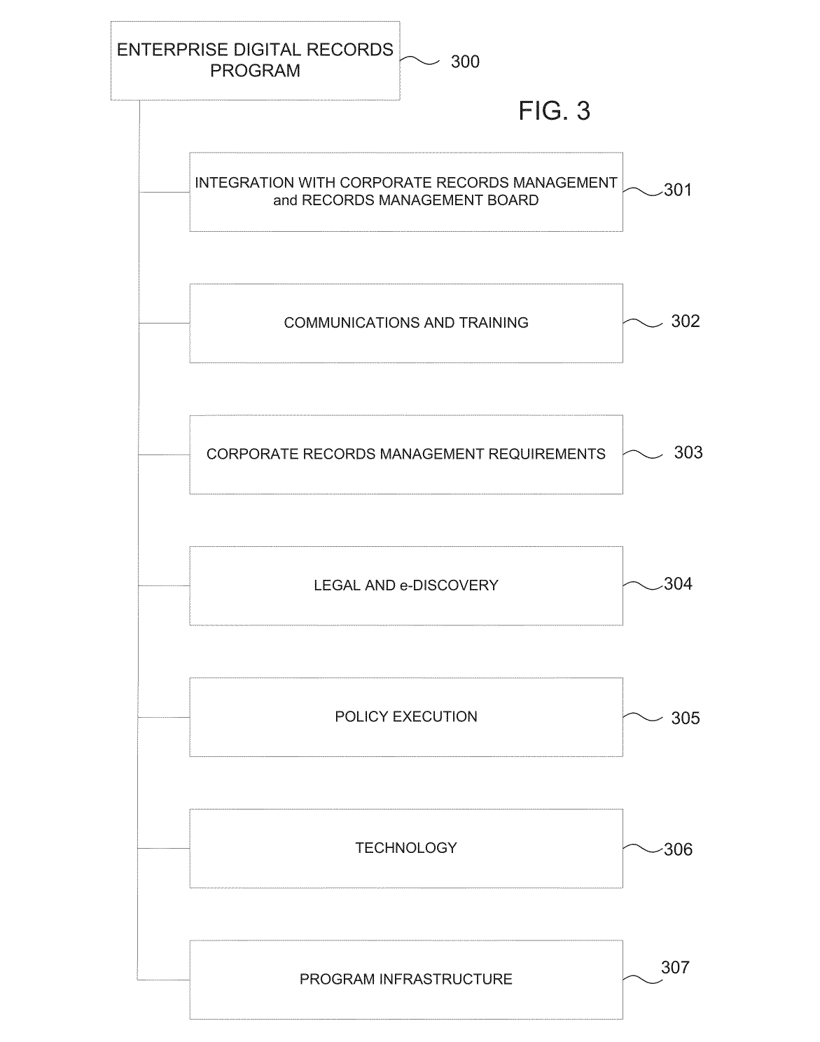

FIG. 3 shows list 300 of project team responsibilities for an enterprise digital records program in accordance with various aspects of the embodiments. The enterprise digital records management program may provide several benefits for the business enterprise. Systems may be implemented to digitize paper and processes, and efficiencies may be gained from digitizing. It may be faster and easier to find and retrieve documentation for business use as well as meet audit, legal and regulatory discovery requirements. Costs may be significantly reduced by eliminating paper, where appropriate and cost-effective. Instituting digital records management throughout the lifecycle of corporate records also supports risk management goals and the corporate commitment to the environment.

Responsibility list 300 includes responsibilities 301-307.

Integration with Corporate Records Management 301: Communications and collaboration channels; integration with a records management board (typically a group of experts that are knowledgeable about records management within the business enterprise); long term planning with the digital records program.

Communications and Training 302: Communications planning and rollout; user documentation, training development; coordination with corporate records management for communications and training.

Corporate Records Management Requirements 303: File plan development; retention policy management; records management roles.

Legal and e-Discovery 304: Litigation notification process; policy updates; legal and regulatory requirements; industry standards and best practices.

Policy Execution 305: Assessment pipeline management; project prioritization; tracking and reporting financial benefits.

Technology 306: Enterprise content management; metadata rollout; records management platform.

Program Infrastructure 307: Program management office (PMO) activities; financial management; tracking and reporting; problem resolution.

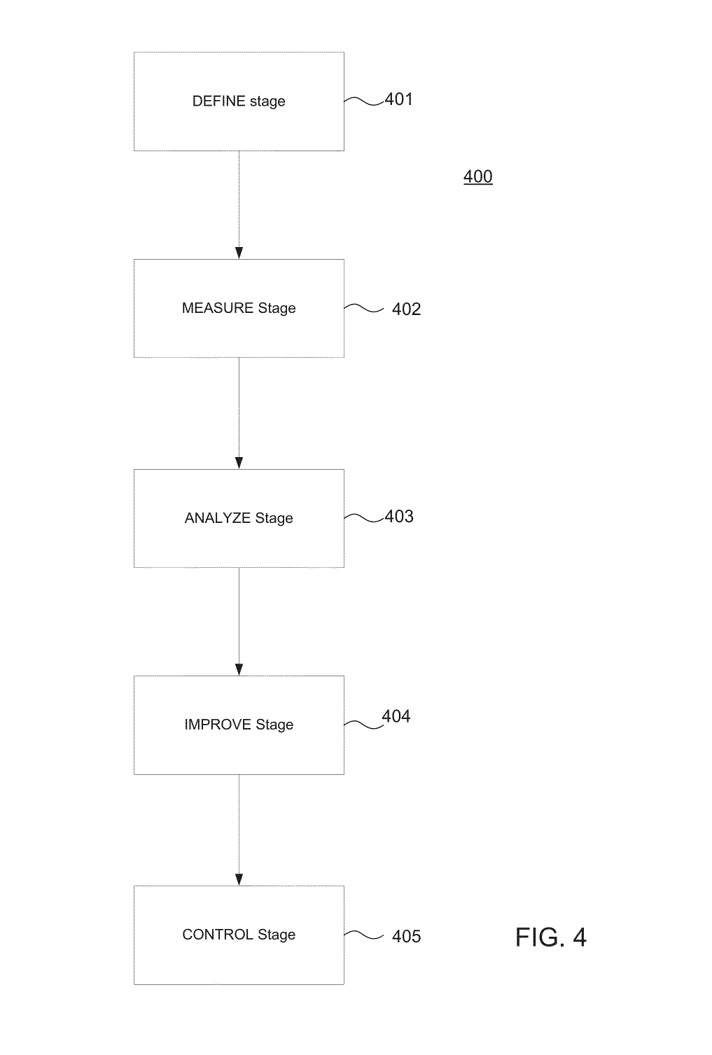

FIG. 4 shows project activities process 400 for an enterprise digital records program in accordance with various aspects of the embodiments. In order to implement an enterprise digital records policy, a business unit, in conjunction with the digital records program team, conducts current state assessments and develops action plans to meet business, legal and regulatory requirements for trustworthy digital records and recordkeeping systems. As will be further discussed, process 400 includes define stage 401, measure stage 402, analyze stage 403, improve stage 404, and control stage 405.

In the flow diagrams shown in FIGS. 5 and 7-10, process blocks are layered to show the corresponding relationship to different organizations within the business enterprise in accordance with some of the embodiments. LOB (line of business) is the business unit for which a business process is being assessed. PMO (program management office) is the organization in the business enterprise that oversees the migration of paper records to digital records. RMGB (records management governance board) is typically a group of experts in records management that certify business processes.

FIG. 5 shows a flow diagram during define stage 401 of an enterprise digital records program in accordance with various aspects of the embodiments. A purpose of define stage 401 is to prepare for assessment and gather required documentation.

In stage 401 the business unit (in particular responsible members of the business unit) reads a statement of the digital records policy and program. The business unit identifies a business process that may utilize digital records. (A business unit may identity one or more processes, where each process may have different owners.) The owner of the process is identified and performance is integrated into the process owner's performance and development plan.

Registration for assessing the process is initiated by taking an online survey at block 501 and registration is completed at block 503. Documentation is submitted at block 505 that may include pre-work policy implementation checklist 551 and business case wizard tool 552.

Pre-work policy implementation checklist 551 may include current environment documentation such as an assessment workgroup contact list and roles, business unit's organization chart, electronic to electronic process maps, technology diagrams demonstrating the chain of custody and control points, legal and regulatory guidance, audit findings, and regulation and law impacts.

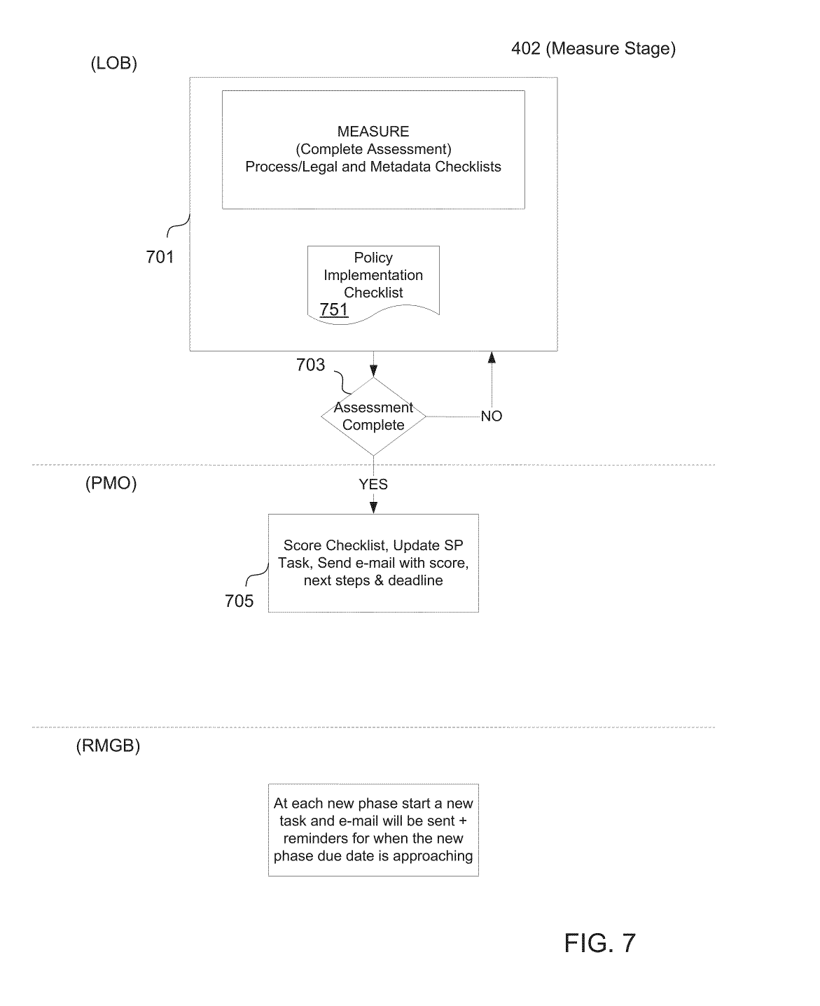

In order to complete stage 401, the registration survey should be completed, and assessment pre-work questions should be answered and documented in policy implementation checklist 551. Once the pre-work is completed at block 507, the measure stage is initiated as will be discussed with FIG. 7.

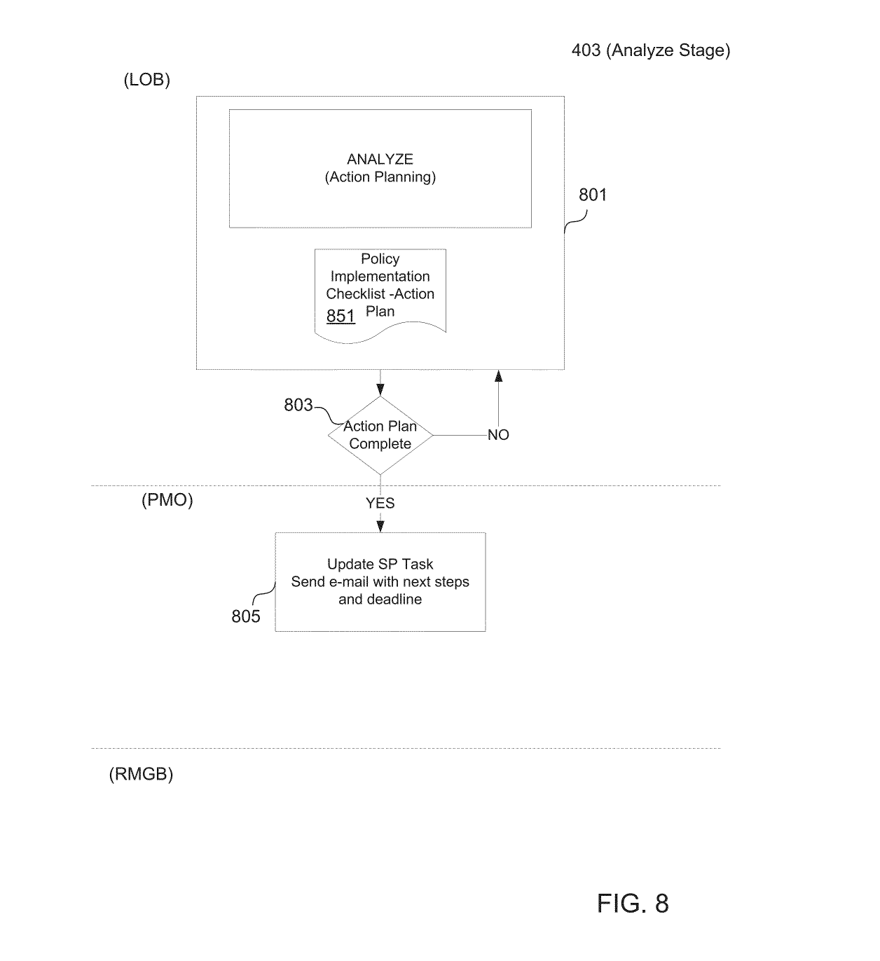

The policy implementation checklist (also known as assessment tool or assessment and certification tool) (shown as checklist 551 during the define stage) may be used during other stages of assessment. With some embodiments, additional worksheets (with respect to checklist 551) may be completed during subsequent stages. For example, during measure stage 402 policy implementation checklist 751 (as shown in FIG. 7) may be updated by the business unit (e.g., a line of business) to include a business process requirements worksheet with key process requirements based on regulation, standards and policy that the business unit should meet as well as information needed for planning and gap mitigation. Policy implementation checklist 751 may also include metadata requirements that each enterprise technology and repository that manages and stores records should contain, populate and transfer to the records repository with the record object. During action stage 403 an action plan worksheet may be completed to facilitate planning to mitigate gaps and to achieve certification and included in policy implementation checklist 851 (as shown in FIG. 8). In addition, worksheets may be completed during various stages of the assessment to show approval of documents and to score assessment completeness based on formulas and responses entered on other worksheets. In addition to the implementation checklist, the total assessment package may include supporting documentation (such as business process flow charts or technology flow charts).

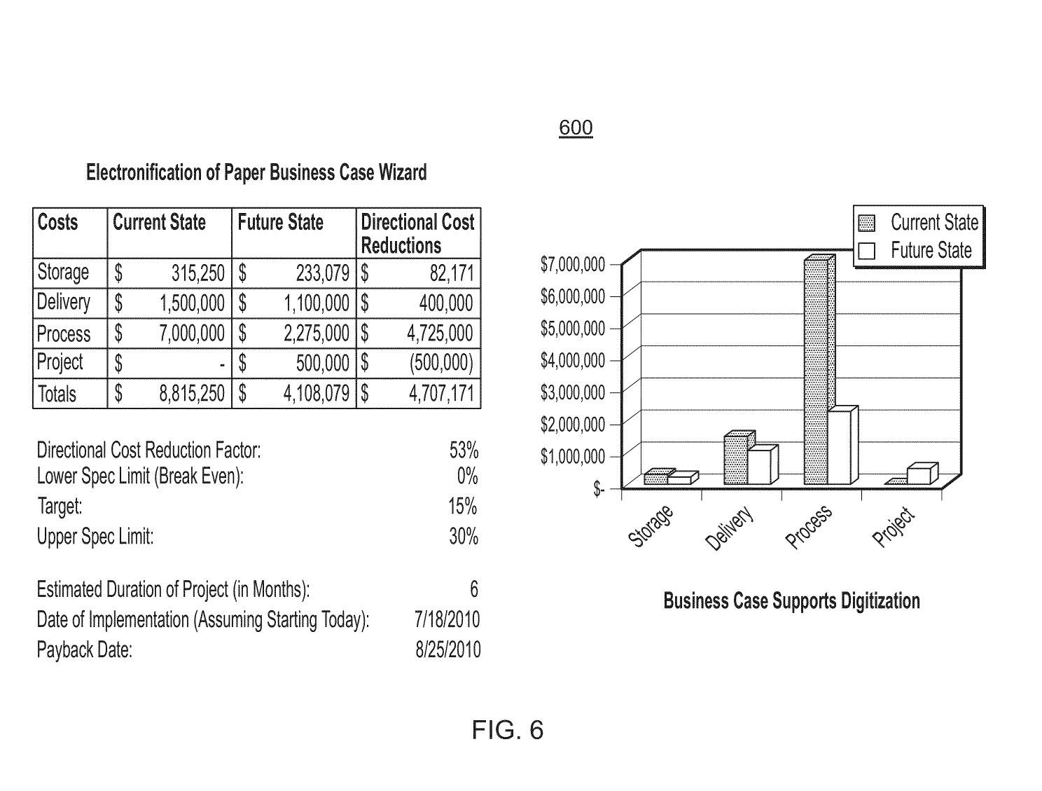

FIG. 6 shows illustrative summary sheet 600 of a business case wizard tool in accordance with various aspects of the embodiments. One of the goals of the business case wizard tool is to evaluate potential financial benefits of migrating to digital records from paper records. With some embodiments, the business case wizard tool may be implemented as a spreadsheet in which the business unit enters data about current paper documentation usage, and based on assumptions, a projected cost savings is determined for constructing a business case. However, while cost savings may be an important incentive to migrating to digital records, there are typically other incentives such as improved access and security of records.

FIG. 7 shows a flow diagram during measure stage 402 of an enterprise digital records program in accordance with various aspects of the embodiments. At block 701 process, legal and metadata checklists are completed and included in policy implementation checklist 751. When the assessment is completed, as determined by block 703, the worksheets are scored at block 705. An assessment is performed on the information submitted in the completed assessment and on the business process and related technologies for compliance based on accuracy, durability, integrity, retrievability, and destruction of paper and digital records per retention schedule (absent the need for a legal hold). Gaps are identified regarding compliance to the digital records policy, and an action plan is created to close the identified gaps. Types of gaps may include the absence of required metadata fields and/or the non-population of the field with needed content; non-alignment of the records maintained by the business with records series within the retention schedule; and storage of data in repositories (e.g., shared drives) that do not meet the requirements for trustworthy electronic records. The business case wizard tool 552 may also be leveraged to evaluate potential benefits.

In order to complete stage 402 process and legal questions and metadata questions should be answered and documented on policy implementation checklist 751. Findings should be documented to include next steps, if changes are required and any requested exceptions submitted to PMO. Exceptions may be directed to an identified gap in which the corresponding economic benefit does not justify deleting the gap.

As previously discussed when referring to FIGS. 1 and 2, computing device 101 and system 200 may utilize knowledge management to manage a digital records program for a business enterprise. Knowledge base content may contain a set of data (often in the form of rules) that specify the enterprise digital policy. A set of rules may include technology and architectural requirements for the digital records management program, information protection requirements, and business process requirements for the digital records management program. For example, the set of rules may specify that all components of a digital record that ensure authenticity are unchanged when stored, digital records are stored on appropriate media during the retention period, and access to digital records is restricted according to strict administration controls. Data entries from the implementation document may then be compared with the set of rules to determine whether there are any gaps in relation to the digital records policy.

FIG. 8 shows a flow diagram during analyze stage 403 of an enterprise digital records program in accordance with various aspects of the embodiments. If questions and gaps were identified during the assessment, the business unit may follow the business as usual change process to develop solutions that ensure compliance with policy at block 801. The business unit may: 1) validate a business case, and develop action plan to close gaps, 2) ascertain that a procedure is included to destroy electronic records and destruction of duplicate paper stored offsite (if applicable), 3) set-up gap closure project(s) for tracking and reporting, 4) prepare for process, administrative and/or system changes, and 5) provide an action plan to program management organization at block 805 when the action plan is completed as determined at block 803. The action may be documented in policy implementation checklist 851.

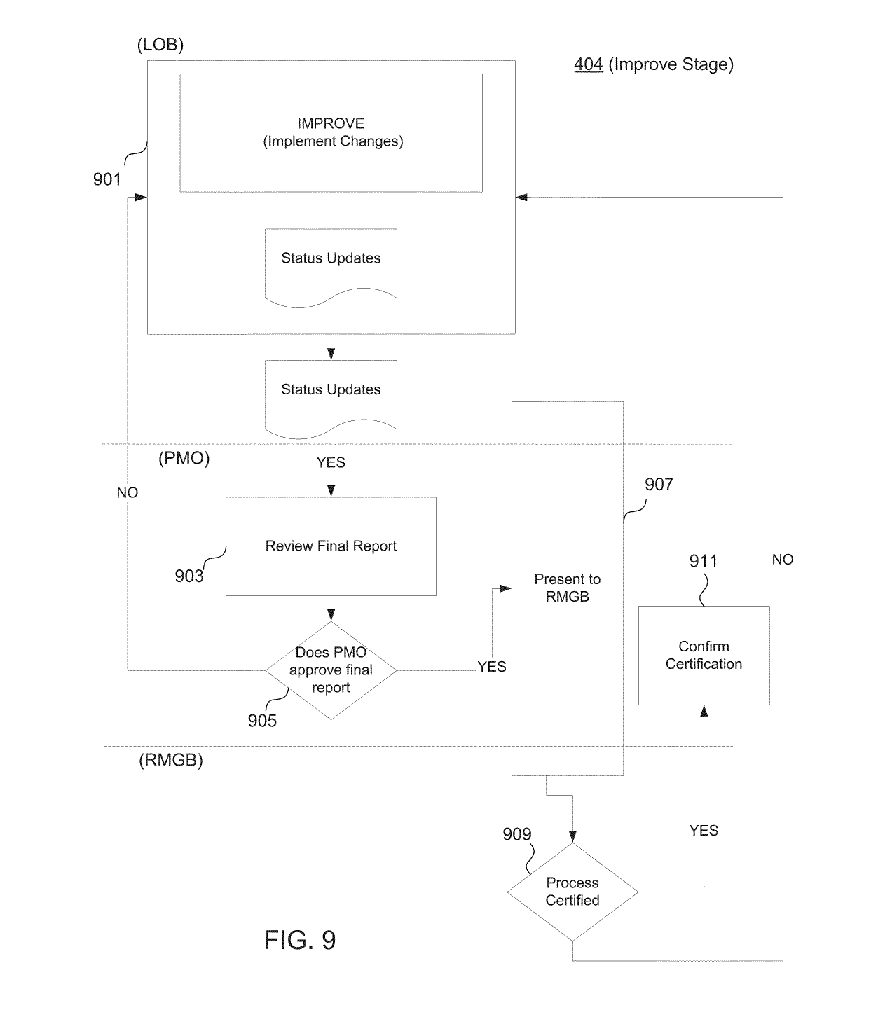

FIG. 9 shows a flow diagram during improve stage 404 of an enterprise digital records program in accordance with various aspects of the embodiments. The purpose of stage 404 includes building, testing, and implementing required changes to the implementation plan and to seek approval and admittance to the digital records program.

At block 901, the business unit continues to follow the business as usual change process, executes changes, and provides status updates to program management organization. The program management organization reviews the final assessment report with the business unit at block 903. If the report is approved at block 905, the report is presented to the records management governance board for approval at block 907. After admittance to the digital records program in blocks 909 and 911, implementation proceeds forward with the digital processes, including destruction of digital records as required, initiating destruction of back file paper records, as appropriate, and ceasing to create hard-copy records going forward.

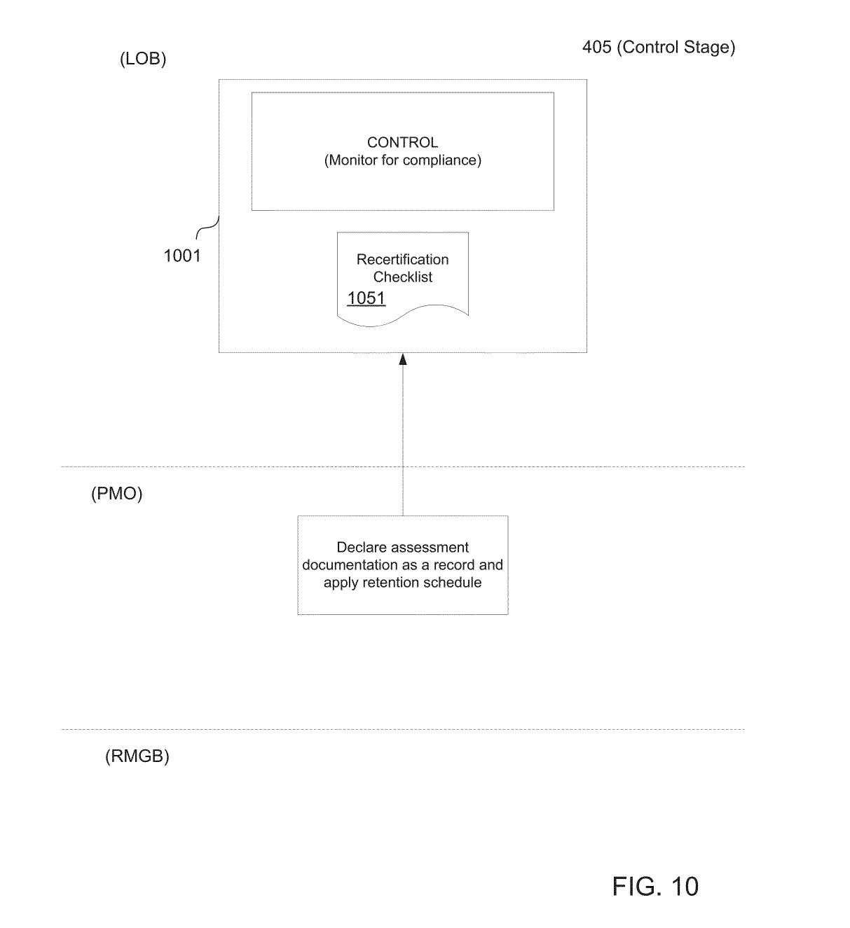

FIG. 10 shows a flow diagram during control stage 405 of an enterprise digital records program in accordance with various aspects of the embodiments. Stage 405 establishes routines for monitoring, reporting and recertification. At block 1001 the control plan is finalized, visual displays of measurements are developed, management routines are confirmed, financial benefits of digital records project(s) are reported, and the digital records program is monitored for compliance. If there are sufficient changes to the digital records program or to the digital records policy, recertification may be needed so that recertification checklist 1051 is completed by the business unit.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
executing a wizard tool to assess a migration to a digital record of a transcribed document, wherein the wizard tool retrieves a plurality of data components from a first storage device of a computer system and wherein the plurality of data components is indicative of benefit factors;
in response to the executing, determining a benefit metric of the migration from the plurality of data components;
when the benefit metric exceeds a predetermined threshold, receiving, by a first business process, before an initiation of any transaction request for storing the digital record to a second storage device of the computer system, an implementation document storing implementation information about the first business process and related technology supporting digital records for a first business unit within a business enterprise, wherein the business enterprise comprises a plurality of business units;
comparing, by at least one processor of the computer system before the initiation, entries from the implementation document with a set of rules that specify the digital records policy of the business enterprise, wherein the set of rules for the digital records policy includes at least one of a technology requirement and an architectural requirement for the computer system;
determining, by the at least one processor, an assessment score during the comparing;
when the comparing is complete, determining, based on the assessment score by the at least one processor before the initiation, whether there is a detected gap between the first business process of the first business unit and the digital records policy of the business enterprise;
identifying, from the detected gap of the business process, whether there is at least one deficiency with one of the data fields in the digital record;
in response to the identifying, removing the detected gap to correct the at least one deficiency with said one data field to obtain a modified digital record; and
storing the modified digital record of the transcribed document on a shared storage drive of the second storage device only when no detected gap occurs.

2. The method of claim 1, further comprising:
providing improvement information for the first business unit to delete the detected gap.

3. The method of claim 1, further comprising:
assessing an economic benefit for deleting the detected gap; and
generating an exception request for the detected gap when the economic benefit is less than the predetermined threshold.

4. The method of claim 1, further comprising:
determining whether to initiate a change in the first business process based on compliance with the digital records policy; and
executing the determined change for the first business process.

5. The method of claim 4, further comprising:
obtaining a certification of the first business process that is indicative of compliance with the digital records policy.

6. The method of claim 5, further comprising:
determining whether the first business process is compliant with the digital records policy of the business enterprise after the certification; and
recertifying the first business process when at least one change in the digital records policy occurs.

7. The method of claim 1, wherein compliance to the digital records policy is based on accuracy, durability, integrity, and retrievably of digital records by the first business unit.

8. The method of claim 7, further comprising:
based on the compliance, detecting an absence of a required metadata field in one of the digital records.

9. The method of claim 7, wherein the compliance is further based on a retention schedule of the digital records.

10. One or more non-transitory computer-readable storage media storing computer-executable instructions that, when executed, cause one or more processing devices to perform:
executing a wizard tool to assess a migration to a digital record of a transcribed document;
in response to the executing, determining a benefit metric of the migration;
when the benefit metric exceeds a predetermined threshold, receiving, by a business process, before an initiation of any transaction request for storing the digital record to a storage device of a computer system, an implementation document storing implementation information about the business process supporting digital records for a business unit within a business enterprise;
comparing entries from the implementation document with a set of rules that specify a digital records policy of the business enterprise before any said transaction request by the business process, wherein the set of rules for the digital records policy includes at least one of a technology requirement and an architectural requirement for the computer system;
determining an assessment score during the comparing;
when the comparing is complete, determining, based on the assessment score before the initiation, whether there is a detected gap between the business process of the business unit and the digital records policy of the business enterprise before storing the digital record of the transcribed document on the computer system;
identifying, from the detected gap of the business process, whether there is at least one deficiency for an alignment of the digital record with a series of digital records within a retention schedule;
removing the detected gap to correct the at least one deficiency with the alignment of the digital record with a series of digital records to obtain a modified digital record; and
storing the modified digital record of the transcribed document on a shared storage drive of the storage device of the computer system only when no detected gap occurs.

11. The one or more computer-readable media of claim 10, wherein the one or more processing devices performs:
assessing a economic benefit for deleting the detected gap; and
generating an exception request for the detected gap when an economic measure of the benefit is less than the predetermined threshold.

12. The one or more computer-readable media of claim 10, wherein the one or more processing devices performs:
determining whether to initiate a change in the business process based on compliance with the digital records policy; and
executing the determined change to the business process.

13. The one or more computer-readable media of claim 12, wherein the one or more processing devices performs:
obtaining a certification of the business process that is indicative of compliance with the digital records policy.

14. The one or more computer-readable media of claim 13, wherein the one or more processing devices performs:
monitoring the business process after the certification of the business process; and
determining whether the business process is compliant with the digital records policy of the business enterprise.

15. A computer system comprising:
a first computing device comprising:
a first memory device;
a first storage device comprising a data repository with at least one shared drive;
a second computing device comprising:
a second memory device;
a second storage device; and
a second processing device coupled to the second memory device and configured to perform, based on instructions stored in the second memory device:
executing a wizard tool to assess a migration to a digital record of a transcribed document, wherein the wizard tool retrieves a plurality of data components from the second storage device and wherein the plurality of data components is indicative of benefit factors;
in response to the executing, determining a benefit metric of the migration from the plurality of data components;
receiving, by a business process, before an initiation of any transaction request for storing the digital record to the first storage device of the first computing device, an implementation document storing implementation information about the business process supporting digital records for a business unit within a business enterprise;
comparing entries from the implementation document, before the initiation of any said transaction request, entries from the implementation document with a set of rules that specify a digital records policy of the business enterprise, wherein the set of rules for the digital records policy includes at least one of a technology requirement and an architectural requirement for the first computing device;
determining an assessment score during the comparing;
when the comparing is complete, determining, based on the assessment score before the initiation of any said transaction request, whether to initiate a change to the business process of the business unit based on compliance with the digital records policy of the business enterprise before storing the digital record of the transcribed document on the first computing device; and
executing, before the initiation of any said transaction request, the determined change to the business process, wherein a detected gap between the business process of the business unit and the digital records policy of the business enterprise is removed and; and
the first processing device coupled to the first memory device and configured to perform, based on instructions stored in the first memory device:
receiving, via a communication channel between the first and second computing devices, an indication about the detected gap;
identifying, from the detected gap of the business process, whether there is at least one deficiency with one of the data fields in the digital record;
removing the detected gap to correct the at least one deficiency with said one data field to obtain a modified digital record; and
storing the digital record of the transcribed document on the at least shared drive of the first storage device of the computer system only when no detected gap occurs.

16. The computer system of claim 15, wherein the second processing device is further configured to perform:
determining whether there is any detected gap from the implementation document and the digital records policy.

17. The computer system of claim 16, wherein the second processing device is further configured to perform:
providing improvement information for the business unit to delete the detected gap.

18. The computer system of claim 17, wherein the second processing device is further configured to perform:
assessing an economic benefit for deleting the detected gap; and
generating an exception request for the detected gap when the economic benefit is less than a predetermined threshold.

19. The computer system of claim 15, wherein the computer system determines whether the business process is compliant with the digital records policy based on accuracy, durability, integrity, and retrievably of the digital records by the business unit.

20. The computer system of claim 19, wherein the computer system further determines whether the business process is compliant whether the digital records policy based on metadata support for the digital records.

21. The method of claim 1, further comprising:
providing, the business enterprise, a core set of documents that can be used to demonstrate due diligence in converting to, implementing, and maintaining a digital records program in accordance with all determined requirements.

22. The method of claim 1, further comprising:
assessing a risk benefit for deleting the detected gap; and
generating an exception request for the detected gap.

23. The method of claim 1, further comprising:
repeating the receiving, the comparing, and the determining for a second business process of a second business unit, wherein the business enterprise comprises the second business unit.

24. The method of claim 1, wherein the determining comprises:
detecting whether storage of the digital records in a data repository is in compliance with a trustworthiness requirement of the digital records policy.

25. The method of claim 1, wherein the determining comprises:
detecting a non-population of a field with required content in one of the digital records.

26. The method of claim 9, wherein the determining comprises:
detecting a non-alignment of one of the digital records with a records series within the retention schedule.

27. The method of claim 1, further comprising:
when any detected gap occurs, revising the first business process to remove all detected gaps; and
in response to the revising, storing the digital record of the transcribed document.

28. The method of claim 1, further comprising:
when the assessment score of the first business process is indicative that the detected gap results from non-compliance of at least one identified requirement, wherein the at least one requirement includes one of the at least one technology requirement and the architectural requirement for the computer system, identifying an action to eliminate the non-compliance; and
in response to the identifying, modifying the implementation document to eliminate the non-compliance of the at least one identified requirement.

29. The method of claim 1, wherein the at least one deficiency is indicative of a non-population of said one field.
